(19) United States
(12) Patent Application Publication
(10) Pub. No.: US 2026/0244012 A1
(43) Pub. Date: Aug. 20, 2026

(54) Hybrid HUD for Extended AR Display and Simplified Integration in a Vehicle

(71) Applicant: Bayerische Motoren Werke Aktiengesellschaft, Muenchen (DE)

(72) Inventors: Sebastian Takeshi LAMPEN, Tokyo (JP); Lutz LORENZ, Deisenhofen (DE)

(21) Appl. No.: 19/489,618

(22) PCT Filed: Jul. 24, 2024
(86) PCT No.: PCT/DE2024/100656

§ 371 Date: Dec. 3, 2025

(30) Foreign Application Priority Data
Sep. 19, 2023 (DE) 10 2023 125 318.2

(51) Int. Cl. G02B 27/01; B60K 35/231; H04N 13/302

(52) U.S. Cl. CPC G02B 27/0101; B60K 35/231; H04N 13/302; B60K 2360/66; G02B 2027/013

(57) ABSTRACT

A projection unit for a head-up display in a vehicle includes a central HUD unit having an image generator for generating a light beam with a central display content and projection and/or imaging optics, so that the light beam leaves the central HUD unit in a predetermined shape and direction towards a reflection pane arranged in the field of vision of a vehicle occupant in order to overlay the display content in the field of vision via reflection on the reflection pane at a predetermined first image distance; and one or more extension displays, the display surfaces of which are directly opposite the reflection pane and connect to the central HUD unit so that the display images thereof seamlessly extend the central display content to the left, right, up and/or down, via reflection on the reflection pane, so as to form a composite virtual image.

### BACKGROUND AND SUMMARY

The invention relates to a projection unit for a head-up display (HUD) for use in a vehicle. Such devices are designed to show a virtual image in the field of view of a user via reflection on a reflection pane, such as a windshield or rear window of the vehicle or a separately provided combiner pane, which is arranged in the field of view of the user. The invention is also directed to an associated operating method, to a correspondingly configured control unit, to a head-up display containing the projection unit, and to a vehicle equipped therewith.

In particular for motor vehicles, overlaying display content such as speed specifications or other useful navigation and vehicle operation instructions in the form of a virtual image of the real surroundings observed by the driver in front of the vehicle by way of a head-up display is known, so that the driver does not have to look away from the road to read this display. For this purpose, an HUD in classic design comprises a projection unit housed below the windshield in the interior of the instrument panel. This projection unit typically contains a display for generating a light beam bundle having desired display content and a suitable imaging and projection optical unit (usually having a concave mirror) to form the light beam bundle and to guide it onto the windshield so that it is reflected therefrom to the eyes of the driver and they can thus see the virtual image in a suitable size and distance beyond the windshield.

An approach is known here for road vehicles for future HUD technologies, in which the virtual image plane is not vertical as usual, but rather is located nearly parallel to the road. A clear depth or 3D effect can thus be created for the observer. As described, for example, in DE 11 2019 003 420 T5, a virtual image which is perceived as adhering to the road surface can therefore be displayed during a journey of a vehicle. For this purpose, an image-generating display area, which absorbs projection light of a projector and displays a real image, is arranged with a comparatively strong inclination in relation to the light axis of the projection light in the interior of the device.

Furthermore, in particular for generating a panoramic virtual display, a simplified HUD design is known, having an image generator which is positioned in relation to the windshield in its windshield base area, so that a real image generated thereby is reflected directly (i.e. without further imaging or deflection optical unit) onto the windshield. This HUD variant is therefore also known as a “simple HUD” or “windshield base display”.

Furthermore, US 2023/0118314 A1 discloses an information display system in a vehicle, in which a classic HUD having a free-form concave mirror for the driver is installed in the instrument panel between the steering wheel and the windshield. The system moreover comprises a simple windshield base display, for example a smart phone, which is arranged in an upper side of the instrument panel between the HUD and the windshield in order to show additional information to the driver in the windshield below the HUD image approximately at the height of the engine hood. Alternatively or additionally, a similar windshield base display opposite to the front passenger seat can be used for a virtual image for the front passenger.

Furthermore, JP 2017-140906 A discloses a display device in a vehicle, in which a classic HUD shows important information, such as vehicle speed etc., to the driver via the windshield via an opening in the upper side of the instrument panel behind the steering wheel. In addition, two flat display screens, which are mounted on guide rails and which in each case are displaceable along the rail away from and toward the driver and at the same time are rotatable around a horizontal axis and usable as direct view displays, are provided on the left and right at a significant distance from this opening. A horizontal position of these flat display screens close to the windshield base is also described, in which they are used as simple HUDs for showing additional information for the driver via the windshield, for example the images of rear-facing cameras on the left and right on the vehicle, which are used as a mirror replacement system for the side mirrors.

It is the object of the present invention to specify a concept for an HUD system in a vehicle, which is an alternative and/or is improved with regard to the installation space, the display options, the display quality, and/or other aspects.

This object is achieved by a projection unit, an associated operating method, a corresponding control unit, a hybrid HUD containing this projection unit, and a vehicle equipped therewith according to the claimed invention. All refining features and effects mentioned in the claims and in the following description for the projection unit also apply with respect to the method, the control unit, the hybrid HUD, and the vehicle, as also vice versa in each case.

According to a first aspect, a projection unit for a head-up display (HUD) for use in a vehicle is provided. The vehicle can be a motor vehicle, but also any other land vehicle, aircraft or watercraft. If not indicated otherwise, all position specifications and spatial orientation terms mentioned herein, such as “vertical”, “horizontal”, “left”, “right”, “in front”, “behind”, “above”, “underneath”, etc. always refer to the typical vehicle-fixed Cartesian coordinate system having longitudinal, transverse, and vertical directions of the vehicle that are perpendicular to one another.

The projection unit firstly comprises a central HUD unit. This comprises an image generator for generating a light beam bundle having central display content, and a projection and/or imaging optical unit formed in the beam path of this light beam bundle such that the light beam bundle leaves the central HUD unit in a predetermined form and direction toward a reflection pane arranged in the field of view of a vehicle occupant, in order to show this display content in the field of view of the occupant via reflection on the reflection pane at a predetermined first virtual image distance of, for example, approximately two, three, four, or more meters from their eyes.

Furthermore, the projection unit comprises one or more extension displays. The display surfaces thereof are each directly opposite to the reflection pane (i.e. without a further optical unit in between) and are closely adjacent here to the central HUD unit from the left and/or from the right in the vehicle transverse direction and/or from the front and/or from the rear in the vehicle longitudinal direction such that their display images, via reflection on the reflection pane, seamlessly extend the central display content accordingly to the left, right, bottom, or top, although at a shorter second virtual image distance, to form a composite virtual image. Each extension display forms a simple HUD with the reflection pane, which can also be referred to as a windshield base display or simple HUD. The second virtual image distance results from the sum of the propagation distances of the projection light from the respective extension display to the windshield and from the windshield to the eyes of the occupant. With routine vehicle configurations, said distance can be, for example, between one and one and a half meters, typically approximately 1.2 m.

The projection unit is designed and configured here for a display of the combined virtual image that is contact-analog, i.e. oriented to real objects outside the vehicle. In other words, the projection unit is designed for AR applications (augmented reality), in which the real surroundings that the occupant observes through a vehicle window are enriched with virtual image content. For this purpose, the projection unit can communicate, for example, with suitable sensor systems onboard the vehicle for capturing the surroundings located outside the vehicle, which sensor systems enable an always up-to-date determination of such objects and generation of virtual images oriented thereto.

One concept here is the combination of a central HUD unit which enables a high-quality contact-analog display having a virtual image distance and/or orientation suitable for this purpose via its projection and imaging optical unit (for example, mirror optical unit), with one or more windshield base displays which ensure a seamless horizontal and/or vertical extension of this virtual display and can be located for this purpose, for example, on the upper housing of the central HUD unit on the left and right (in the vehicle transverse direction) and/or behind and in front (in the vehicle longitudinal direction) of its beam exit opening and directly border/adjoin thereon here, so that no gaps result at the corresponding transition points in the composite virtual image.

For a high-quality contact-analog virtual display, in particular a first virtual image distance can be suitable, which is close to the actual distance of the real objects outside the vehicle that are enriched using this image content. In this case, for example, outstanding results are already achievable using an image distance of approximately 2 m from the eyes of the occupant, wherein depending on the application greater image distances can also be readily suitable, for example up to approximately 10 m, so that the eye has to refocus as little as possible between the real object and the virtual image. Due to a limited installation space in the instrument panel, however, only a small angle range in the field of view of the driver of, for example, approximately 10° in the horizontal direction can be covered using an optical unit required for this purpose. An extension of the central HUD unit beyond this angle range is not possible, because this would result in installation space collisions with other indispensable elements of the vehicle, such as its support structure or the climate control system, etc. However, this angle range is hardly sufficient to also comprise, for example, road and lane boundaries or a hazard lurking at the roadside, such as an animal or human, in a contiguous virtual image.

The present invention is based on a surprising finding that with a seamless extension, in the vehicle transverse and/or vertical direction, of a central image shown in a contact-analog manner with virtual display content having a different image distance, which is implementable using a windshield base display, the eye of the occupant perceives this display content in the composite virtual image as a natural extension of the central image. In this way, a lateral and/or vertical extension of the angle range of a contact-analog overlay by at least 3° each to the left and right or the top and bottom is possible.

According to one embodiment, the central HUD unit is designed to display the central display content in a virtual image plane which is obliquely inclined or horizontal with respect to the vertical direction. For this purpose, the surface of the image generator in which the display content is generated is oriented with a corresponding angle of inclination in relation to an optical axis of the central HUD unit. For example, in this way a tilted virtual image can be generated having an image distance, increasing from bottom to top, of approximately 2-4 m for the lower image edge and approximately 6-20 m for the upper image edge. This embodiment enables a virtual overlay having a depth effect which is similar to real objects outside the vehicle, such as a section of road, and thus strengthens the contact-analog effect.

In principle, any technology is suitable for the image generator of the central HUD unit, in particular a light-transmitting or light-emitting flat display screen, a projector-based image generator, or a waveguide-based display. The respective extension display can be designed, for example, as a light-transmitting or light-emitting flat display screen, in particular a liquid crystal display (LCD) or micro-LED display.

According to one embodiment, the above-mentioned imaging and/or projection optical unit in the central HUD unit comprises at least one concave mirror. The respective concave mirror can be designed, for example, for a deflecting, image-enlarging, imaging, collimating, and/or image-correcting optical function. Alternatively or additionally, the imaging and/or projection optical unit can also comprise other optical elements, however, for example lenses, planar mirrors, or holographic-optical elements, having these or other optical functions.

According to one embodiment, the central HUD unit and/or each of the extension displays are designed for autostereoscopic image generation in order to further strengthen the contact-analog perception of the composite virtual image due to this additional depth effect. For this purpose, for example, technologies known per se for causing a stereoscopic effect can be used in the image generator of the central HUD unit or in the extension displays, which are based on generating display content differing with respect to the perspective for each eye and associated parallax barriers in the form of a strip mask or a lens grid, etc., in order to guide corresponding parts of the projection light generated as a whole only to one eye of the occupant in each case.

In particular, the projection unit can be designed for installation in an instrument panel of the vehicle. The virtual image can thus be overlaid, for example, in the field of view of a driver (or front passenger).

According to a further aspect, a method is for operating a head-up display (referred to hereinafter as hybrid HUD) in a vehicle having the projection unit presented herein. The method comprises the following steps:
determining at least one real object which is located outside the vehicle and extends in a field of view of the occupant that can be virtually covered both by the central HUD unit and by at least one of the extension displays and is to be enriched in a contact-analog manner by virtual image content; and
actuating the central HUD unit and at least one of the extension displays to generate corresponding display content that complements itself via reflection on the reflection pane to form a seamlessly composite virtual image.

In particular, this real object can be a road section which is located in front of the vehicle and the areas of which to be augmented in a contact-analog manner (such as a lane or road boundary) extend to the left and/or to the right and/or upward and/or downward beyond the area that can be covered by the central HUD unit.

According to a further aspect, a control unit is provided, which is designed and configured to automatically carry out this method. For this purpose, for example, a corresponding computer program (software) can be loaded into a processor of the control unit and run during operation of the hybrid HUD.

According to a further aspect, the above hybrid HUD is intended for a vehicle. The hybrid HUD comprises the above projection unit and a reflection pane arranged in the beam path of projection light emitted as a whole thereby. In this case, the reflection pane is arranged/to be arranged in the field of view of a vehicle occupant and designed such that it reflects this projection light to a spatial area (eyebox) predetermined for their eyes in the vehicle interior, by which the mentioned composite virtual image is overlaid in their field of view.

The hybrid HUD furthermore comprises the above control unit which is designed to actuate the central HUD unit and the extension display or the extension displays in order to carry out the above method.

According to a further aspect, the above vehicle is provided. It comprises a passenger compartment and a vehicle window, which at least partially delimits said compartment, in particular a windshield. Furthermore, the hybrid HUD, which is presented herein and the projection unit of which is arranged in the passenger compartment, in particular in an instrument panel arranged below the windshield and the reflection pane of which is designed as a section of the mention vehicle window or as a combiner pane arranged in the passenger compartment, is provided in the vehicle.

The above aspects of the invention and the embodiments and specific designs thereof will be explained in more detail hereinafter on the basis of the examples illustrated in the appended drawings. The drawings are predominantly schematic and therefore are to be understood as not to scale.

### BRIEF DESCRIPTION OF THE DRAWINGS

FIG. 1 shows a longitudinal sectional view of a vehicle having a hybrid HUD according to an exemplary embodiment of the invention, which is designed for a contact-analog display of a composite virtual image for a driver via reflection on a windshield.

FIG. 2 shows a perspective view of the hybrid HUD of FIG. 1 in a view from the passenger compartment in the direction of travel, wherein outlines of its central HUD unit and both extension displays, which are installed so that they are invisible to the occupants in or below an upper side of the instrument panel, are indicated.

FIG. 3 shows a perspective view of the vehicle of FIGS. 1 and 2 from the viewpoint of the driver with an example of a virtual image generated in a contact-analog manner by the hybrid HUD.

### DETAILED DESCRIPTION OF THE DRAWINGS

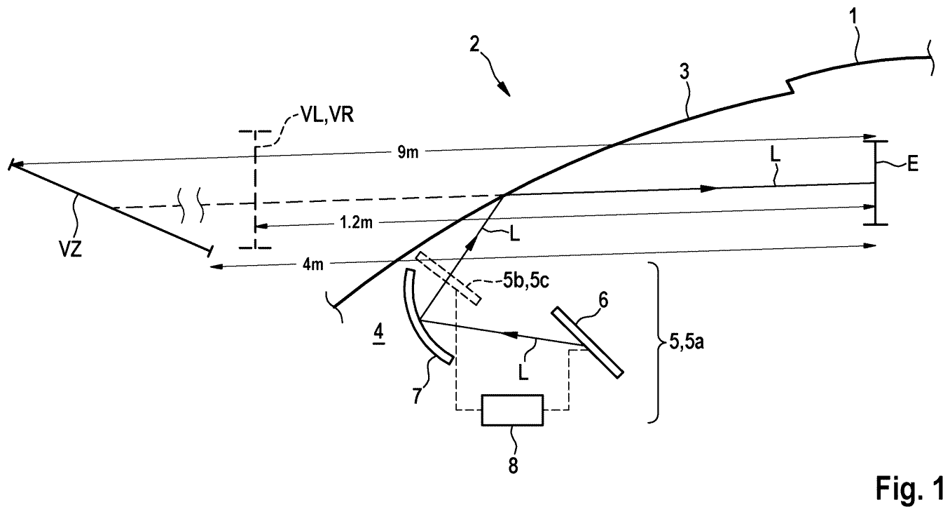

All of the different embodiments, variants, and specific design features, mentioned above in the description and in the following claims, of the projection unit, of the method, of the control unit, of the hybrid HUD, and of the vehicle according to the above aspects of the invention can be implemented in the examples shown in FIGS. 1-3, in particular also alternatively or additionally to the features shown therein. They are therefore not all repeated once again hereinafter. The same applies accordingly to the term definitions and effects already indicated further above with respect to individual features shown in FIGS. 1 to 3.

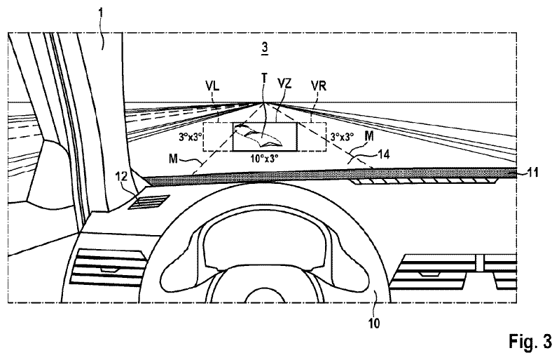

FIG. 1 shows a very simplified schematic longitudinal sectional view of an exemplary embodiment of a vehicle 1 having a hybrid HUD 2 which is presented herein and is designed to generate a virtual image VZ+VL+VR composited seamlessly in the vehicle transverse direction (cf. FIG. 3 from another perspective) in the field of view of a driver of the vehicle 1.

The vehicle 1 is in this example a motor vehicle, which is indicated in FIG. 1 only by its windshield 3, which is used as the reflection pane of the hybrid HUD 2. A projection unit 5 of the hybrid HUD 2 is arranged thereunder in an instrument panel 4 (not shown in more detail). The driver is only indicated by a spatial area E (eyebox) intended for their eyes in the vehicle interior, from which they can see the composite virtual image VZ+VL+VR in the intended quality.

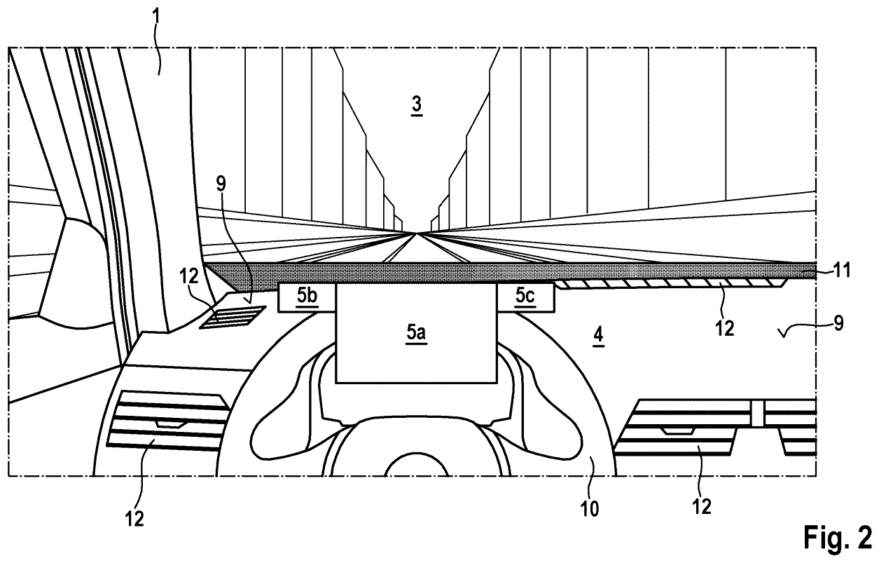

The projection unit 5 is composed of a central HUD unit 5a and, solely by way of example, two extension displays 5b and 5c (not included in the longitudinal sectional plane of FIG. 1, therefore only shown by dashed lines; cf. FIG. 2) arranged on the left and right on its upper housing (not shown separately).

The central HUD unit 5a contains an image generator 6, in this example an LCD (liquid crystal display), which is designed to generate a central display content. The light beam bundle L originating from its display surface is indicated in simplified form by a center beam, which leads approximately from a center of this display surface into a center of the eyebox E. In the further beam path of the light beam bundle L, the central HUD unit 5a comprises a concave mirror 7. In this case, the image generator 6 and the concave mirror 7 are arranged and designed so that the light beam bundle L leaves the central HUD unit 5a in a suitable form and direction in order to subsequently be reflected from the windshield 3 to the eyebox E and thus display to the driver the central display content as the central virtual image VZ having desired display properties in a contact-analog manner. In this example, the image generator 6 or its display surface is arranged at an oblique setting angle with respect to the mentioned center beam, in order to generate a correspondingly obliquely inclined, nearly horizontal virtual image plane at 4 m (lower image edge) to 9 m (upper image edge) from the eyebox E. The setting angle of the image generator 6 can also be selected differently than in FIG. 1, for example to generate a nearly vertically oriented central virtual image VZ.

The extension displays 5b and 5c are directly opposite to the windshield 3, i.e. without a further optical unit therebetween, wherein the display images thereof are seamlessly adjacent on the left and right to the central virtual image VZ as virtual extension images VL and VR (better visible in FIG. 3) via reflection on the windshield 3 and thus extend this central virtual image to form a composite contact-analog virtual image VZ+VL+VR in the field of view of the driver. Alternatively or additionally thereto, one or two extension displays can be arranged in front or behind in the vehicle longitudinal direction in a similar manner on the mentioned upper housing of the HUD unit 5a, in order to extend its central virtual image VZ in a seamless and likewise contact-analog manner downward and/or upward.

Furthermore, the projection unit 5 comprises a control unit 8, which is configured to carry out a method according to an exemplary embodiment of the invention and is designed for corresponding actuation of the extension displays 5b and 5c and the image generator 6. The method comprises, inter alia, the following steps:
determining at least one real object which is located outside the vehicle 1 and extends in an area in the field of view of the driver that can be virtually covered both by the central HUD unit 5 a and also by at least one of the extension displays 5b/5c and is to be enriched in a contact-analog manner by virtual image content; and
actuating the central HUD unit 5 a and the extension displays 5b/5c to generate corresponding display content, which complement one another seamlessly via reflection on the windshield 3 in the vehicle transverse direction to form a composite virtual image VZ+VL+VR.

FIG. 2 shows a perspective view of the hybrid HUD 2 in the vehicle 1 of FIG. 1 in a view from the passenger compartment in the direction of travel. Only for the sake of clarity, in addition to the windshield 3, also the outlines of its central HUD unit 5a and both extension displays 5b and 5c are schematically indicated here: In fact, the projection unit 5 (cf. FIG. 1) is installed so that it is invisible to the occupants in and below an upper side 9 of the instrument panel 4. To further clarify the positions and sizes of the central HUD unit 5a and both extension displays 5b and 5c in the vehicle 1, moreover a steering wheel 10, a so-called black print 11 (darkening) along the lower edge of the windshield 3, and multiple air outlet openings 12 of a climate control system installed in the instrument panel 4 are shown in FIG. 2. Since the hybrid HUD 2 is designed for AR applications, a transparent area of the windshield 3 located above the black print 11 is used for the virtual image display.

Due to the vertical size, indicated in FIG. 2, of the central HUD unit 5a which is required for its optical arrangement according to FIG. 1, there is no space in the interior of the instrument panel 4 for an extension of the central HUD unit 5a with this optical unit to the left and right, without installation space collisions occurring with a support structure (not shown), the climate control system, and other vehicle elements. Using extension displays 5b and 5c which are directly adjacent to an upper housing of the central HUD unit 5a and claim only little installation space in the vehicle vertical direction in comparison thereto as windshield base displays, the central virtual image VZ (see FIGS. 1 and 3) can be extended to the left and right in the field of view of the driver without losing the contact-analog effect, as illustrated on the basis of an example in FIG. 3.

FIG. 3 shows a perspective view of the vehicle 1 of FIGS. 1 and 2 from the viewpoint of the driver with an example of a composite virtual image VZ+VL+VR generated in a contact-analog manner by the hybrid HUD 2. In this example, in the above method, a road section 14 located in front of the vehicle 1 is enriched with virtual image content in order to indicate to the driver a suitable lane change trajectory T and associated lane markings M in a clearly discernible manner.

As can be seen in FIG. 3, the virtual display area which is required in the display of the lane change trajectory T for the lane markings M (for example in the case of a snowy or unmarked roadway), extends to the left and right beyond the angle range in the field of view of the driver which can be covered by the central HUD unit 5a alone and here, solely by way of example, comprises a horizontal angle of approximately 10° and a vertical angle of approximately 3°. As proposed herein, the required contact-analog lane markings M are achieved by virtual extension images VL and VR with the aid of the above extension displays 5b and 5c, which each cover, solely by way of example, an angle range of approximately 3°×3° in FIG. 3, which seamlessly adjoins on the left and right the above central angle range of 10°×3°, in which the central virtual image VZ is displayed.

### LIST OF REFERENCE SIGNS

1 vehicle
2 hybrid HUD
3 windshield
4 instrument panel
5 projection unit
5a central HUD unit
5b, 5c extension display
6 image generator
7 concave mirror
8 control unit
9 upper side of the instrument panel
10 steering wheel
11 black print
12 air outlet openings
14 road section
L light beam bundle
E eyebox
VZ central virtual image
VL, VR virtual extension images
T lane change trajectory
M lane markings

1.-10. (canceled)

11. A projection unit for a head-up display for a vehicle, the projection unit comprising:
a central HUD unit having an image generator for generating a light beam bundle having a central display content and a projection and/or imaging optical unit formed in a beam path of the light beam bundle such that the light beam bundle leaves the central HUD unit in a predetermined form and direction toward a reflection pane arranged in a field of view of a vehicle occupant, in order to overlay the central display content in the field of view via reflection on the reflection pane at a predetermined first virtual image distance; and
one or more extension displays, display surfaces of which are each directly opposite to the reflection pane and are adjacent to the central HUD unit such that their display images extend the central display content to the left, right, top, and/or bottom seamlessly via reflection on the reflection pane and at a shorter second virtual image distance, to form a composite virtual image;
wherein the projection unit is configured for a display of the composite virtual image that is oriented to real objects outside the vehicle.

12. The projection unit according to claim 11, wherein
the central HUD unit is configured to display the central display content in a virtual image plane which is obliquely inclined or horizontal with respect to a vertical direction, and an image-generating surface of the image generator is oriented at a correspondingly predetermined angle of inclination in relation to an optical axis of the central HUD unit.

13. The projection unit according to claim 11, wherein
the projection and/or imaging optical unit comprises at least one concave mirror.

14. The projection unit according to claim 11, wherein
the central HUD unit and/or each of the extension displays are configured for autostereoscopic image generation.

15. The projection unit according to claim 11, wherein
the projection unit is configured for installation in an instrument panel of the vehicle to overlay the virtual image in a field of view of a driver.

16. A method for operating the head-up display in the vehicle having the projection unit according to claim 11, the method comprising:
determining a real object which is located outside the vehicle and extends in the field of view of the vehicle occupant in an area that can be virtually covered both by the central HUD unit and by at least one of the extension displays and is thus to be enriched in a contact-analog manner; and
actuating the central HUD unit and at least one of the extension displays to generate corresponding display content, which complement one another via reflection on the reflection pane to form a seamlessly composite virtual image.

17. The method according to claim 16, wherein
the real object is a road section which is located in front of the vehicle and the area to be enriched in a contact-analog manner using virtual image content extends to the left, right, bottom, and/or top beyond the area in the field of view of the vehicle occupant which can be covered by the central HUD unit.

18. A control unit which is configured to automatically carry out the method according to claim 16.

19. A hybrid HUD for the vehicle, the hybrid HUD comprising:
the projection unit according to claim 11; and
a reflection pane which is arranged in a beam path of projection light output as a whole by the projection unit and which is arranged in the field of view of the vehicle occupant and configured such that the reflection pane reflects the projection light to an eyebox predetermined for eyes of the vehicle occupant, by which the composite virtual image is overlaid in the field of view.

20. The vehicle having longitudinal, transverse, and vertical directions, perpendicular to one another, of a vehicle-fixed Cartesian coordinate system, the vehicle comprising:
a passenger compartment having a vehicle window, which at least partially delimits the passenger compartment; and
the hybrid HUD according to claim 19, the projection unit of which is arranged in the passenger compartment, and the reflection pane of which is configured as a section of the vehicle window or as a combiner pane arranged in the passenger compartment.

21. The projection unit according to claim 20, wherein the vehicle is a motor vehicle.

22. The projection unit according to claim 20, wherein the vehicle window is a windshield.

23. The projection unit according to claim 22, wherein the projection unit is arranged in an instrument panel below the windshield.
